(19) United States
(12) Patent Application Publication
(10) Pub. No.: US 2009/0063272 A1
(43) Pub. Date: Mar. 5, 2009

(54) Method, system and computer-readable media for acquiring, providing and responding to data, requests and commands related to real property rental

(76) Inventors: John Topete, Union City, CA (US); Timothy Christopher Gunderman, Brentwood, CA (US)

Correspondence Address: PATRICK REILLY, P.O. Box 7218, Santa Cruz, CA, 95061-7218, US

(21) Appl. No.: 11/897,934

(22) Filed: Aug. 30, 2007

(51) Int. Cl. G06Q 20/00; G06Q 40/00

(52) U.S. Cl. 705/14; 705/30; 705/39

(57) ABSTRACT

A method, system and computer-readable media for generating a renter account associated with an individual person. In a first version, an information technology system enables (a.) accepting rental payment performance information of the person; (b.) storing the rental payment performance information in a database record of the information technology system; (c.) associating a database record with the rental account; and (d.) receiving permission from the individual to release the rental payment performance information to at least one landlord.

### FIELD OF THE INVENTION

The present invention relates to enabling the management of information of value or interest to the real estate industries. The present invention more particularly relates to information technology systems that maintain databases containing information relevant to the real estate industries.

### BACKGROUND OF THE INVENTION

The prior art offers inefficient and not especially appropriate techniques for providing information about potential tenants to a landlord (lessor). Unlike a typical merchant who exchanges goods or services for on-the-spot payments, a landlord is contracting to exchange the use and possession of his property for a significant time period in exchange for the tenant's promise to make periodic future rent payments. Standard credit checks generally do not reveal rental-payment defaults.

Traditionally rent is paid in monthly installments, with only funds covering one month's rental payment being held as a security deposit against the possibility of a rent-payment default. If a tenant fails to timely pay rent, the landlord's primary recourse is to seek eviction of the tenant, so as to free the premises for rental to a new tenant. Eviction proceedings are generally cumbersome, state laws routinely requiring various pre-eviction notices to the tenant and court hearings, and then reliance on action through the sheriffs office or the like. An eviction proceeding routinely will take more than one month's time to complete after it is commenced—therefore a one-month's security deposit will not be full compensation to the landlord. Actual collection of the unpaid rent typically requires a separate, additional court proceeding, with its own monetary and time-consumption costs, with no guarantee that any judgment awarded will be collectable.

The prior art provides no generally available method or means for determining a potential tenant's rental-payment history. Contacting prior landlords is time consuming, and there is no certainty that the person identified by a potential tenant is in fact a prior landlord. Attempting to track a rent-payment history through court records of eviction and collections proceedings is even more burdensome, and the absence of court proceedings in a given jurisdiction is no guarantee that a potential tenant has not walked away from one or more prior tenancies without full rent payment.

The prior art includes (1.) United States Patent Application Publication No. 20020169641 that discloses a method of qualifying a renter; and (2.) United States Patent Application Publication No. 20070055618 that presents a method and system to determine resident qualifications.

The prior art further includes U.S. Pat. No. 6,738,751 that claims a credit card rental-cost payment method; U.S. Pat. No. 6,049,784 that teaches a method for creating and managing a lease agreement; and U.S. Pat. No. 6,502,080 that describes an automatic lease residual management system; and U.S. Pat. No. 6,898,574 that discloses a lender and insurer transaction processing system and method.

Each and every patent application and patent mentioned in the present disclosure, to include United States Patent Application Publication No.'s 20020169641 and 20070055618; and U.S. Pat. Nos. 6,738,751; 6,049,784; 6,502,080; and 6,898,574 are incorporated by reference into the present disclosure in their entirety and for all purposes;

There is therefore a long-felt need to provide landlords or their agents with information particularly relevant to evaluating the future rental payment performance of an individual potential renter.

### SUMMARY OF THE INVENTION

Towards this object and other objects that will be made obvious in light of this disclosure, a first preferred embodiment of the method of the present invention, or “first method”, applies an information technology system to acquire rental payment information. The first method may enable or support various alternate or optional aspects of the method of the present invention, such as (a.) recording a rental credit history of a person, partnership, or corporation; (b.) rating the quality of a renter through on time payment recordation and capturing; (c.) associating a renter with a renter identification; (d.) associating a property with a property identification; (e.) associating a renter identification with a property identification; (f.) generating a credit score for use by landlords or other parties in evaluating potential renters; and/or (g.) generating sales leads for the use of landlords or their agents in identifying and screening potential renters.

The first method includes (a.) generating a renter account associated with an individual person; (b.) accepting rental payment performance information of that individual; (c.) storing the rental payment performance information in a database record of the information technology system, the database record associated with the rental account; and (d.) receiving permission from the individual to release the rental payment performance information to at least one landlord. In certain versions of the first method, the rental payment performance information may be provided by a payee, e.g., a landlord, and/or an individual renter.

An information technology system may practice the first method in combination with an electronics communications network, such as a telephony network, the Internet, an intranet, a extranet, or other suitable digital electronics communications systems or networks known in the art.

Various optional, additional or alternative aspects of certain alternate preferred embodiments of the method of the present invention enable or include (a.) a party paying a subscription fee to view a plurality of renter database records, wherein each database record is associated with a unique individual renter; a party paying a per record fee to view a single renter database records, wherein each database record is associated with a unique individual; (c.) a party to preferentially considering renting a property to an individual having an associated renter account; (d.) a party electing to offer a preferential property rental term to the individual identified by the associated renter account; (e.) a party offering a rental agreement that includes a rental payment discount; (f.) a party offering a rental agreement that includes a security deposit discount.

Certain still alternate preferred embodiments of the method of the present invention include providing an information technology system that enables or supports one or more of the following optional aspects of the present invention: (1.) accepting a property rental payment from the individual; (2.) updating the database record associated with the individual with data describing the property rental payment; (3.) receiving a fee from the landlord for accepting the property rental payment from the individual’ (4.) offering a renter a credit account for making a property rental payment to the landlord; (5.) making a property rental payment to a landlord as authorized by a renter; (6.) charging an interest rate for the property rental payment after submission to the landlord; (7.) accepting rental payment performance information from the landlord; and (8.) updating the database record associated with a renter with data describing property rental payments.

A second alternate preferred embodiment of the method of the present invention includes providing an information technology system that includes (a.) means for generating a renter account associated with an individual person; (b.) means for accepting rental payment performance information of the person; (c.) means for storing the rental payment performance information in a database record of the information technology system, the database record associated with the rental account; and (d.) means for receiving permission from the individual to release the rental payment performance information to at least one landlord.

A third alternate preferred embodiment of the method of the present invention provides a computer-readable medium comprising machine-executable instructions that direct an information technology system to instantiate or execute one or more aspects of the first method, including (a.) generating a renter account associated with an individual person; (b.) accepting rental payment performance information of the person; (c.) storing the rental payment performance information in a database record of the information technology system, the database record associated with the rental account; and (d.) receiving permission from the individual to release the rental payment performance information to at least one landlord.

In certain other alternate preferred embodiments of the method of the present invention a rental payment history may be verified and consider within an application process application for a mortgage on a real property, such as a residential property.

In certain still other alternate preferred embodiments of the method of the present invention a computer-readable media having information that associates an individual with a rental history record may be provided on an identity card. The identity card may be of the size shape and form of a bank, debit, or credit card, such as an American Express™ financial account card.

The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which:

FIG. 1 is a process diagram of a prior art approach to securing a rental agreement;

FIG. 2 is a process diagram of the first method of the method of the present invention;

FIG. 3 is a schematic of an information technology network through which the first method may be practiced;

FIG. 4 is a schematic of an information technology system, e.g., a computer, through which the first method may be practiced;

FIG. 5 is a schematic of a system software including a database software that may be comprised within the information technology network of FIG. 3, the computer of FIG. 4, and/or distributed within the computer and the information technology network;

FIG. 6 is a schematic of a renter's record that may be stored within the system software of FIG. 5;

FIG. 7 is a schematic of a property record that may be stored within the system software of FIG. 5; and

FIG. 8 is a process chart of an integration of a consideration of a rental payment history within an application process application for a mortgage on a real property, such as a residential property.

### DETAILED DESCRIPTION OF A PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result.

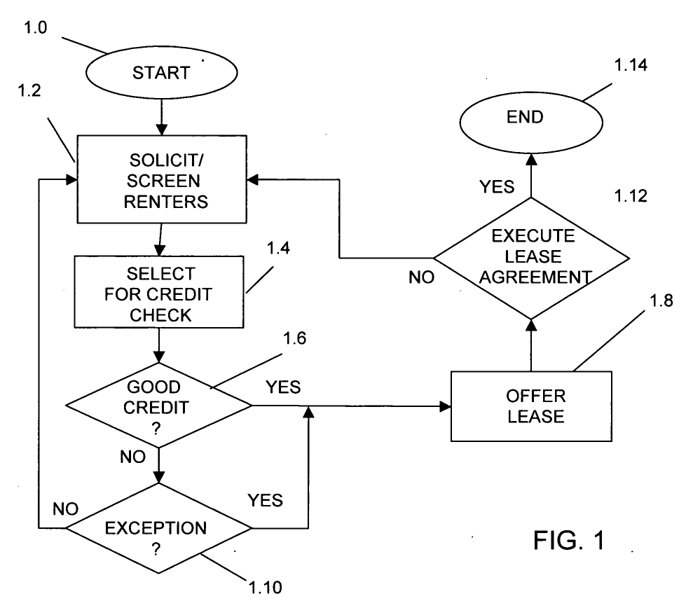

Referring now generally to the Figures and particularly to FIG. 1, FIG. 1 is a process diagram of a prior art approach to securing a rental agreement. In step 1.2 a person, property owner, partnership or corporation seeking to rent a real property (hereafter “landlord”) solicits and screens renters. In step 1.4 the landlord performs a prior art credit check on one or more selected renter candidates. Prior art credit checks are of marginal utility, as many renters have little or spotty credit history in comparison with homeowners. Additionally, prior art credit checks typically are conducted on a fee basis and therefore cost burden the prior art methods of evaluating the credit worthiness of potential renters.

The landlord reviews credit check results in step 1.6. and may proceed on to offer a lease in step 1.8 to a potential renter when the credit check results reviewed in step 1.6 are sufficiently positive. Alternatively, the landlord may opt to make an exception in step 1.10 and proceed on to step 1.8 to offer a lease even when the potential renter has a poor credit history. The landlord may otherwise proceed from step 1.10 to step 1.2 to seek out other potential renters.

The landlord may attempt to complete a lease agreement in step 1.12 with a selected renter candidate, and if failing to may proceed from step 1.10 to step 1.2 to seek out other potential renters.

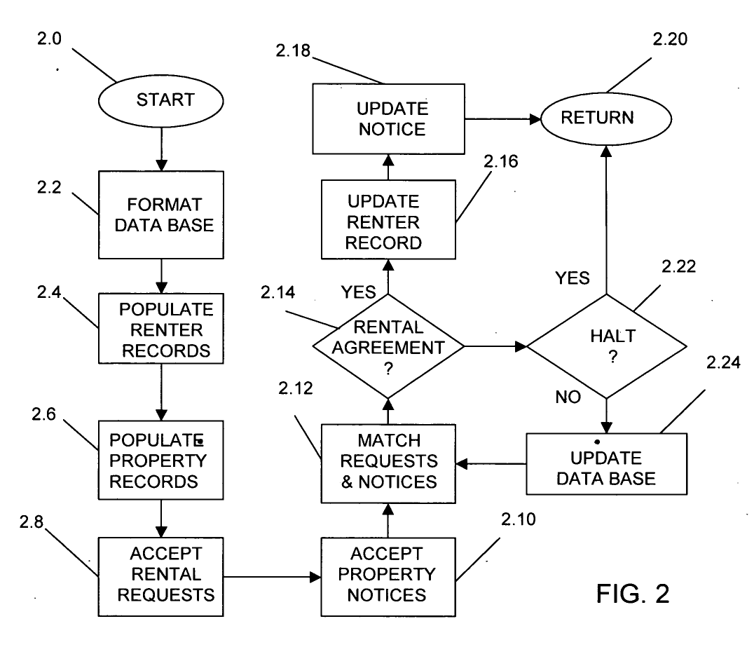

Referring now generally to the Figures and particularly to FIG. 2, FIG. 2 is a process diagram of the first method of the method of the present invention. In step 2.2 a database of an information technology system is formatted to include renter records and property records. A plurality of renter records are populated in step 2.4 with information related to renters, wherein each unique renter record retains information related to a particular person. A plurality of property records are populated in step 2.4 with information related to properties, wherein each unique renter record retains information related to a particular property and a landlord associated with the property. A database manager (hereafter “DBMS”) of the information technology system accepts requests from rental properties in step 2.8 and notices of property rental availability in step 2.10.

In step 2.12 the computer automatically matches rental requests with property notices by means of a credit engine of the system software, and in step 2.14 rental agreements may be executed by issuance of a rental agreement offer by a landlord and acceptance of the rental agreement offer by a renter candidate. A renter record associated with the accepting renter of step 2.16 is updated to note the commencement of a new rental term, and the property notice referred to in the rental agreement offer of step 2.14 is updated in step 2.18. The computer may proceed from step 2.18 to step 2.20 to other processing that may include (1.) returning to step 2.4 to update existing renter records or create new renter records, (2.) returning to step 2.6 to update existing property records or create new property records; and/or any step 2.8 through 2.18. Alternatively, the computer may proceed from step 2.14 to step 2.22 to determine whether the process of matching rental requests and property notices shall be continued or halted. Where the computer determines in step 2.22 to continue the process of matching rental requests and property notices, the computer proceeds from step 2.22 to update the database in step 2.24 and therefrom to execute step 2.12.

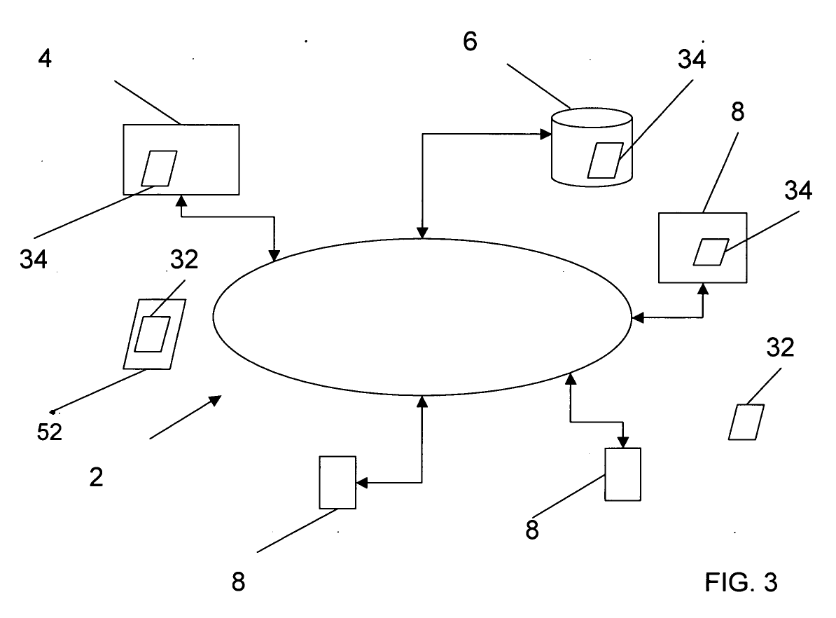

Referring now generally to the Figures and particularly to FIG. 3, FIG. 3 is a schematic drawing of an electronics communications network 2 that includes a computational system 4 (hereafter “computer” 4) providing a software database function. The electronics communications network 2 (hereafter “network” 2) includes a plurality of database systems 6 and computer workstations 8. The computer 4, the database systems 6, and the computer workstations 8 may comprise, or be comprised within, (1.) a personal computer configured for running WINDOWS XP™ operating system marketed by Microsoft Corporation of Redmond, Wash., (2.) a computer workstation configured to run, and running, a LINUX or UNIX operating system, and/or (3.) other suitable computational system known in the art configured for software database management and accessibility. In particular, the computer 4 may be a computer system, such as (a.) a VAIO FS8900™ notebook computer marketed by Sony Corporation of America, of New York City, N.Y., (b.) Posiflex Jiva 5815™ point of sale computer station marketed by Posiflex Technologies, Inc., or (c.) other suitable computational system known in the art, and configured for wireless and/or landline connectivity with the Internet and/or the World Wide Web. In addition, the computer 4, one or more workstations 8, and one or more database systems 6 may be or comprise (1.) a SUN SPARCSERVER computer workstation marketed by Sun Microsystems of Santa Clara, Calif. running LINUX or UNIX operating system; (2.) a personal computer configured for running WINDOWS XP™ operating system marketed by Microsoft Corporation of Redmond, Wash.; or (3.) a PowerBook G4™ personal computer as marketed by Apple Computer of Cupertino, Calif.

In certain alternate preferred embodiments of the method of the present invention the network 2 may be or comprise a wireless telephone network and the computer 4 may comprise a wireless personal digital assistant or a cellular telephone, such as (1.) a Nokia Model E61™ cellular telephone marketed by Nokia Corporation of Espoo Finland; or (2.) a BLACKBERRY™ wireless personal digital assistant marketed by Research-in-Motion of Waterloo, Ontario, Canada.

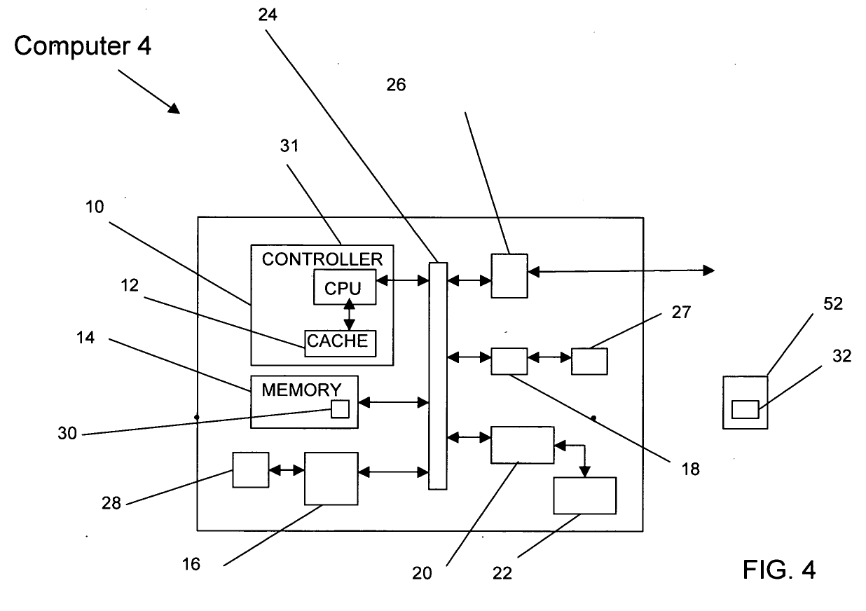

Referring now generally to the Figures and particularly to FIG. 4, FIG. 4 is a schematic drawing of the computer 4 of the network 2. The computer 4 includes a central processing unit 10 (hereafter “CPU” 10), a cache memory of the CPU 12, a system memory 14, a data input device interface 16, a display device interface 18, an optional media reader interface 20, an optional media writer/reader 22, an internal communications bus 24, and a network communications interface 26. The network communications interface 26 may bi-directionally communicatively couple the computer 4 to the network 2 and/or a wireless telephony network comprised within the network 2. The CPU 10, the system memory 14, the data input device 16, the display device interface 18, the optional media reader interface 20, and the network interface 26 are communicatively coupled by means of the internal communications bus 24. The network communications interface 26 communicatively couples the computer 4 with the network 2 via the CPU 10 and the internal communications bus 24. The optional media reader interface 20 communicatively couples the media writer/reader 22 with the CPU 10 and the system memory 14 by means of the internal communications bus 24. The display device 18 interface communicatively couples a display device 27, e.g., a liquid crystal display device, to the CPU 10 via the internal communications bus 24. The data input device interface 16 communicatively couples an input device, such as a keyboard and computer mouse module 28 with the CPU 10 via the internal communications bus 24. The system memory 14 stores a system software 30 of the computer 4. The CPU 10 and the cache memory may be comprised within a unified controller 31.

The media writer/reader 22 is configured to read a computer-readable and machine executable instructions stored within a computer-readable medium 32 and transmit the read instructions to the CPU 10 and the system memory 14. The terms “computer-readable medium” and “computer-readable media” 32 as used herein refer to any suitable medium known in the art that participates in providing instructions to the network and/or the computer. Such a medium may take many forms, including but not limited to, non-volatile media, volatile media, and transmission media. Non-volatile media includes, for example, optical or magnetic disks, such as may be comprised within the system memory.

Volatile media includes dynamic memory. Transmission media includes coaxial cables, copper wire and fiber optics. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer system can read.

Various forms of computer-readable media 32 may be involved in carrying one or more sequences of one or more instructions to the network for execution. For example, the instructions may initially be carried on a magnetic disk of a remote server. The remote server can load the instructions into its dynamic memory and send the instructions over a telephone line using a modem. A modem local to or communicatively linked with the network can receive the data on the telephone line and use an infra-red transmitter to convert the data to an infra-red signal. An infrared detector can receive the data carried in the infrared signal and appropriate circuitry can provide the data to the network.

It is understood that the workstations 8 and database systems 6 of the network may comprise some or all of the aspects and elements of the computer 4 disclosed herein optionally along with additional suitable aspects and elements known in the art.

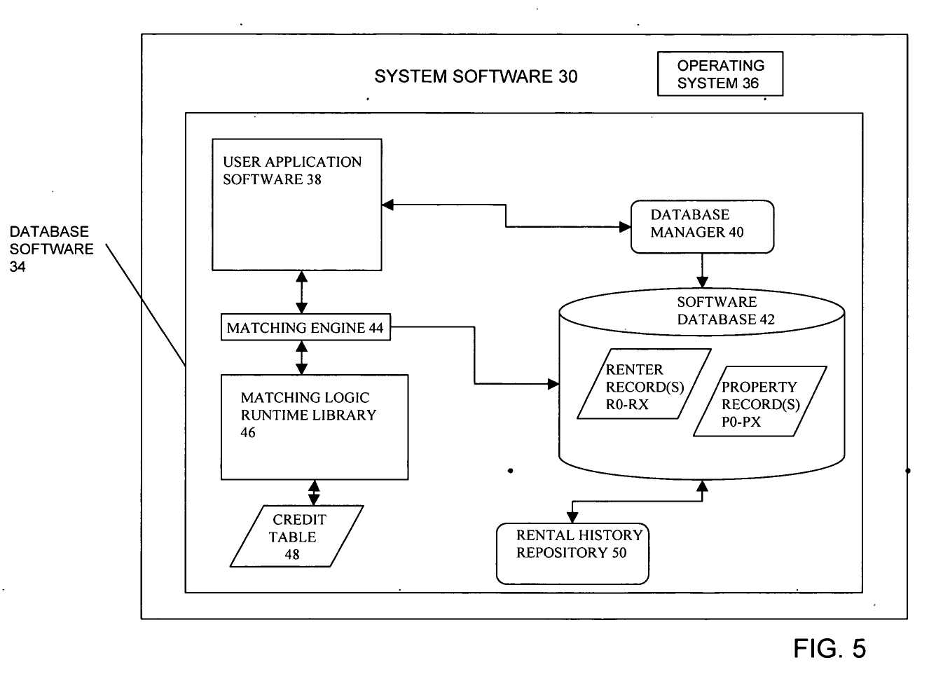

Referring now generally to the Figures and particularly to FIG. 5, FIG. 5 is an entity diagram of a database software 34 of the system software 30 that is maintained on or accessible to the computer 4 and/or the network 2 of FIG. 1. The database software 34 might include combination of (1.) an object oriented database and DBMS, (2.) an IBM DB2 Universal Database™ server (in Linuk, UNIX®) marketed by IBM Corporation of Armonk, N.Y.; (3.) WINDOWS™ operating system environments marketed by Microsoft Corporation of Redmond, Wash.; and (4.) multiple data sources to which the client query application sends queries.

The computer 4 or network 2 may host system software 30 and operating system 36 that includes user application software 38 useful to manage input and output communications between the computer 4, database system 6 and/or workstation 8 hosting the system software 30. A database manager 40 accepts rental requests, property notices, queries, instructions, commands and data from a computer 4, 6, or 8, or the network 2, and thereupon accesses and modifies a software database 42 in compliance with the received rental requests, property notices, queries, instructions, commands and data.

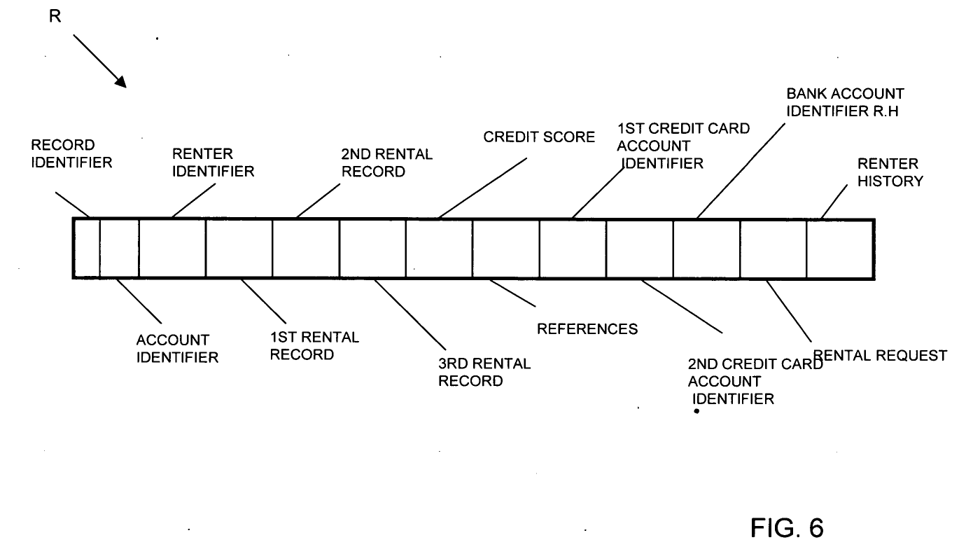

Each renter record R0-RX is associated with a schema R of FIG. 6 of a software object or other suitable data structure known in the art, whereby an instantiation of a record R0-RX is performed according to a schema associated with the instant record R0-RX. In addition, each property record P0-PX is associated with a schema of FIG. 6 of a software object or other suitable data structure known in the art, whereby an instantiation of a property record P0-PX is performed according to a schema associated with the instant property record R0-RX.

The database manager 40 (hereafter “DBMS”) enables commands and queries provided from or sourced by the user application software 38 or a matching engine 44 to be applied to the renter records R0-RX and the property records P0-PX of the software database 42. A matching engine logic 46 directs the matching engine 44 to modify evaluate records R0-RX in accordance with information regarding credit evaluations stored within a credit table 48, to include an evaluation of a renter's rental payment history. A rental history record of transactions associated with a particular record R of records R0-RX may be maintained in a transaction history repository 50.

In certain still other alternate preferred embodiments of the method of the present invention the computer-readable media 32 may include information that associates an individual with a rental history record R0-RX may be provided on an identity card 52, as per FIG. 1. The identity card may be of the size shape and form of a bank, debit, or credit card, such as an American Express™ financial account card.

Referring now generally to the Figures and particularly to FIG. 6, FIG. 6 is a schematic of a renter's record R0-RX that may be stored within the system software 30 of FIG. 5. A record identifier uniquely identifies the record within the data base software 34. It is understood that the data base software may be stored within the computer 4, a work station 8 or a database system 6, or distributively stored within the network 2 and one or more computer-readable media 32. A renter account identifier links the record R with other renter records R0-RX and other information stored within the data base software 34. Renter identifier associates the record R with a particular renter, e.g., a human being, a corporation or a business. A first rental record includes information concerning the rental payment history of the renter, as identified by the renter identifier, and in relationship to a specific real property rental agreement. A second rental record includes information concerning the rental payment history of the renter and in relationship to a second real property rental agreement. A third rental record includes information concerning the rental payment history of the renter and in relationship to a third real property rental agreement. A credit score records information provided by one or more third party credit evaluation services. A references data includes personal and business references that the renter authorizes a landlord to contact regarding evaluation as a potential renter. A first credit account identifier includes a credit account available to the renter. A second credit account identifier includes a second credit account available to the renter. A bank account identifier includes a second credit account available to the renter. A rental request includes information provided in a rental request of step 2.8 of the process of FIG. 2. And renter history information is stored in a renter history data field.

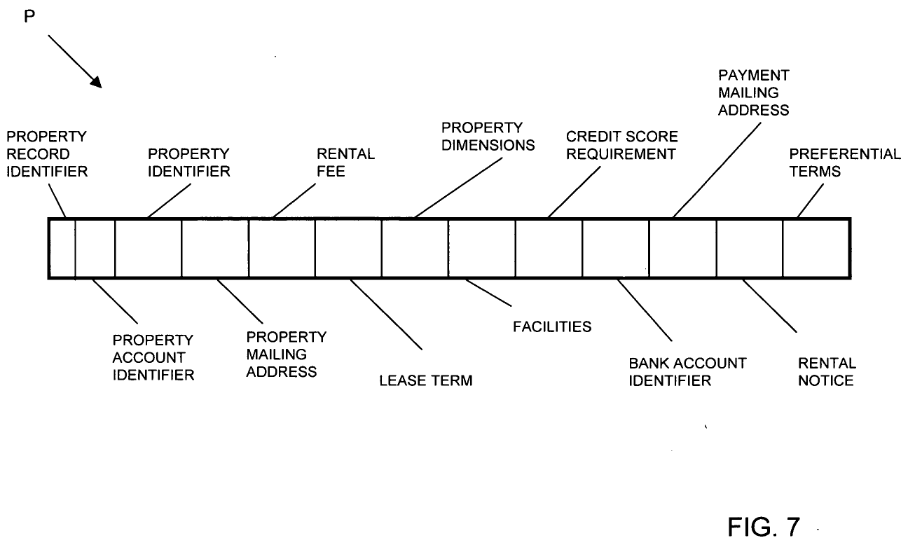

Referring now generally to the Figures and particularly to FIG. 7, FIG. 7 is a schematic of a property record P0-PX that may be stored within the system software 30 of FIG. 5.

A property record identifier uniquely identifies the property record within the data base software 34. A property account identifier links the property record P with other property records P0-PX and other information stored within the data base software 34. A property identifier associates the record R with a particular landlord, e.g., a human being, a corporation or a business. A mailing address identifies the property's mailing address. A rental fee specifies the amount of rent and payment terms required by the landlord. A lease term specifies the time period length of lease offered by the landlord. The dimensions of the property and within the property, e.g., square footage of rooms, is provided. Facilities are described, e.g., bathrooms, parking locations. A credit score assigned to a renter as required by the landlord for consideration as a renter candidate is specified. A bank account identifier informs the renter where to deposit checks electronically. A rent mailing information lists a mailing address for rent payments. A rental notice data filed includes information provided in a property notice request regarding the property. And a preferential terms data field includes improved rental terms that might be made available to a renter who subscribes to the first method and has a renter record.

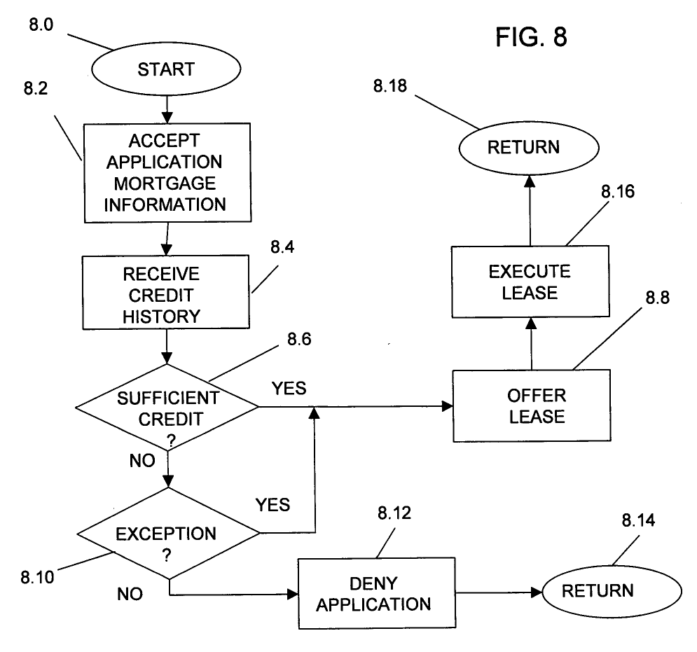

Referring now generally to the Figures and particularly to FIG. 8. FIG. 8 is a process chart of an integration of a consideration of a rental payment history within an application process application for a mortgage on a real property, such as a residential property. In step 8.2 a bank, a financial institution, person, property owner, partnership or corporation seeking to rent a real property (hereafter “lender”) accepts mortgage application information regarding a mortgage applicant. In step 8.4 the lender receives a prior art credit history of the mortgage applicant.

The lender reviews the prior art credit history in step 8.6. and may proceed on to offer a mortgage in step 8.8 to the mortgage applicant when the credit history reviewed in step 8.6 are sufficiently positive to comprise an established and sufficient credit history.

Alternatively, the lender may opt to make an exception in step 8.10 on the basis of a rental payment history of the mortgage applicant and proceed therefrom on to step 8.8 to offer a mortgage to the mortgage applicant even when the mortgage applicant has a poor credit history. The lender may otherwise proceed from step 8.10 to step 8.12 to deny the mortgage application of step 8.2 and proceed on to other activities in step 8.14

The lender may attempt to complete a lease agreement in step 8.16 with the mortgage applicant, and if failing to execute a mortgage agreement in step 8.16, the lender may proceed from step 8.16 to step 8.2 to seek out other mortgage applications. The lender may otherwise proceed from step 8.16 after executing a mortgage agreement onto other activities in step 8.18.

The foregoing disclosures and statements are illustrative only of the Present Invention, and are not intended to limit or define the scope of the Present Invention. The above description is intended to be illustrative, and not restrictive. Although the examples given include many specificities, they are intended as illustrative of only certain possible embodiments of the Present Invention. The examples given should only be interpreted as illustrations of some of the preferred embodiments of the Present Invention, and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Therefore, it is to be understood that the Present Invention may be practiced other than as specifically described herein. The score of the Present Invention as disclosed and claimed should, therefore, be determined with reference to the knowledge of one skilled in the art and in light of the disclosures presented above.

We claim:

1. In an information technology system, a method for acquiring rental payment information, the method comprising:
generating a renter account associated with an individual person;
accepting rental payment performance information of the person;
storing the rental payment performance information in a database record of the information technology system, the database record associated with the rental account; and
receiving permission from the individual to release the rental payment performance information to at least one landlord.

2. The method of claim 1, wherein a payee of rental payments due from the individual provides rental payment performance information.

3. The method of claim 1, wherein the individual provides rental payment performance information.

4. The method of claim 1, wherein the information technology system is comprised within the Internet.

5. The method of claim 1, wherein the landlord pays a subscription fee to view a plurality of database records, wherein each database record is associated with a unique individual.

6. The method of claim 1, wherein the landlord pays a per record fee to view any one of a plurality of database records, wherein each database record is associated with a unique individual.

7. The method of claim 1, wherein the landlord elects to preferentially consider renting a property to any individual having an associated renter account.

8. The method of claim 1, wherein the landlord elects to offer a preferential property rental term to the individual identified by the associated renter account.

9. The method of claim 8, wherein the preferential rental term includes a rental payment discount.

10. The method of claim 8, wherein the preferential rental term includes a security deposit discount.

11. The method of claim 1, further comprising accepting a property rental payment from the individual.

12. The method of claim 11, further comprising automatically updating the database record associated with the individual with data describing the property rental payment.

13. The method of claim 11, further comprising receiving fee from the landlord for accepting the property rental payment from the individual.

14. The method of claim 1, further comprising offering the individual a credit account for making a property rental payment to the landlord.

15. The method of claim 13, further comprising making a property rental payment to the landlord as authorized by the individual.

16. The method of claim 14, further comprising charging an interest rate for the property rental payment after submission to the landlord.

17. The method of claim 1, further comprising accepting rental payment performance information from the landlord.

18. The method of claim 17, further comprising automatically updating the database record associated with the individual with data describing the property rental payment.

19. An information technology system, comprising;
means for generating a renter account associated with an individual person;
means for accepting rental payment performance information of the person;
means for storing the rental payment performance information in a database record of the information technology system, the database record associated with the rental account; and
means for receiving permission from the individual to release the rental payment performance information to at least one landlord.

20. A computer-readable medium comprising machine-executable instructions that direct an information technology system to:
a. generate a renter account associated with an individual person;
b, accept rental payment performance information of the person;
c. store the rental payment performance information in a database record of the information technology system, the database record associated with the rental account; and
d. receive permission from the individual to release the rental payment performance information to at least one landlord.
